(19) United States
(12) Patent Application Publication
(10) Pub. No.: US 2021/0095081 A1
(43) Pub. Date: Apr. 1, 2021

(54) POLYMERIC FILM AND LAMINATED GLASS CONTAINING THE SAME

(71) Applicant: CHANG CHUN PETROCHEMICAL CO., LTD., Taipei (TW)

(72) Inventors: Cheng-Fan WANG, TAIPEI (TW); Chin-Yen CHANG, TAIPEI (TW)

(21) Appl. No.: 16/584,172

(22) Filed: Sep. 26, 2019

(51) Int. Cl. C08J 5/18; C08K 5/11; C08K 5/05; C08K 5/053; C08K 5/13; B32B 17/10; B32B 27/22; B32B 27/30

(52) U.S. Cl. CPC C08J 5/18; B32B 2605/08; C08K 5/05; C08K 5/053; C08K 5/13; B32B 17/10036; B32B 17/10761; B32B 27/22; B32B 27/30; C08J 2329/14; B32B 2250/03; B32B 2250/40; B32B 2307/412; B32B 2307/418; B32B 2315/08; B32B 2329/06; B32B 2419/00; B32B 2605/006; C08K 5/11

(57) ABSTRACT

A polymeric film comprising a polyvinyl acetal resin a plasticizer and a blending agent containing an aliphatic ring and at least one hydroxyl group are disclosed. A laminate is also described where the polymeric film is used as the interlayer between two transparent materials such as glass. The laminate made using the polymeric film has excellent optical and impact resistance properties.

### FIELD OF THE INVENTION

The present disclosure relates to polymeric films that can be used as an interlayer for a laminate. In particular interlayer polymeric films for a laminate and the laminate made with the same.

### BACKGROUND

Laminated glass is constructed using two pieces of glass held together by an interlayer made of a clear thermoplastic film such as polyvinyl butyral (PVB) or ethylene-vinyl acetate (EVA). In addition to holding the two pieces of glass to each other, the plastic film keeps the glass bonded even when it is broken. This offers a safety feature, as a “safety glass” when there is possibility of human impact from large shards of glass or objects passing through glass during catastrophic failure that causes the glass to shatter. For example, these types of laminated glass are commonly used in vehicles such as automobiles, as well as in buildings such as for skyscrapers, skylights and hurricane-resistant construction. In other applications, laminated glass is also used to improve sound insulation for windows. These laminated glasses may also provide other benefits, such as a reduction in ultraviolet (UV) and/or infrared (IR) radiation, and may also enhance the aesthetic appearance of windows by the addition of color, texture, and the like. Additionally, laminated glass with desirable acoustic properties has also been produced, which results in quieter internal spaces.

Although laminated glass technologies have been known for more than a century there remain challenges. Often the polymers selected for desirable properties, such as acoustic performance, lack other desirable properties, such as high impact resistance or strength. Therefore, modern laminated glass technologies have evolved to complex formulations combining thermoplastic resins with several different additives. These additives must be carefully balanced and selected and can often lead to unexpected undesirable properties in addition to any improvements.

For example, one group of additives that are often used is an adhesion control agent. These can be metal salts such as magnesium and potassium acetates which work by modulating the hydrogen bonding between the thermoplastic and glass. It has been found, however, that these salts can agglomerate or precipitate, which consequently impacts the transparency of the laminated glass, for example, due to light scattering by the agglomerated particles. To obviate this negative effect, where high transparency is desired such as for automobile windshields, one solution is to decrease the concentration of the adhesion control agent used. However, this decrease can cause poor penetration resistance. Another solution is to add a dispersion agent which prevents the agglomeration of the metal salt additives. Although a possible solution, the dispersion agents are often low boiling compounds which cause other defects such as bubble formation which again negatively impact the transparency and impact resistance of the laminated glass.

High haze can also occur when different types of optically incompatible polymers and/or plasticizers are blended or mixed together. Therefore, blending agents are also needed so that the resin and smaller molecules can be mixed together homogeneously. For example, glycol ethers have been used as reported in WO 2016/094205 A1 1 as blending agents to reduce the haze caused by resins used in laminated glass.

Clearly the preparation of laminated glass requires exacting and sometimes difficult to control processes, including complex formulations, often where different requirements such as good adhesion and high transparency must be balanced. There therefore remains a need for improved transparent laminates such as laminated glass having high optical transparency, low haze, low yellowness and high impact resistance which can provide better safety glass for vehicles and better architectural glass for buildings.

### SUMMARY

In general, the inventions described herein relate an interlayer and laminate using this interlayer. For example, a laminate having a high impact resistance and high transparency.

In a first aspect, the invention comprises a polymeric film comprising a polyvinyl acetal resin, a plasticizer and a blending agent containing an aliphatic ring and at least one hydroxyl group. Optionally, the blending agent an alicyclic alcohol. Optionally, the aliphatic ring comprises an alicyclic hydrocarbon group, for example, wherein the alicyclic hydrocarbon group has 3 to 12 carbons. Optionally, wherein the alicyclic hydrocarbon group is selected from the group consisting of a cycloalkyl, a fused bicycloalkyl, a spiroalkyl, a bridged bicycloalkyl, and a first cycloalkyl linked to a second cycloalkyl by a C₁-C₃ alkyl chain. Optionally the aliphatic ring is substituted with at least one hydroxyl group or at least one hydroxyl substituted(C₁-C₆) alkyl. Optionally, the blending agent is at least one selected from the group consisting of tricyclodecane dimethanol (TCDDM), 1,4-cyclohexanedimethanol (CHDM), 2,2′-bis(4-hydroxycyclohexyl)propane (HBPA), decahydro-2-naphthol, cyclohexanol, and 1,4-cyclohexanediol. For example, optionally the blending agent is tricyclodecane dimethanol (TCDDM). Optionally, the blending agent contains at least two hydroxyl groups. Optionally the polyvinyl acetal resin is polyvinyl butyral resin. Optionally the plasticizer comprises triethylene glycol bis(2-ethylhexanoate) (3GO). In some options, the blending agent is used in an amount of at least 0.005 phr. Optionally the refractive index of the polymeric film is at least 1.460.

In a second aspect, the invention includes a laminate comprising an outer transparent laminae and an interlayer comprising the polymeric film according to the first aspect. Optionally the outer transparent laminae are glass. Optionally the transparency of the laminate is greater than 88.28. Optionally the yellowness index of the laminate is less than 0.30. Optionally the mean break height is greater than 4.50 meters.

In a third aspect, the invention includes a laminate comprising two outer layers of glass and an interlayer of a polymeric film comprising a polyvinyl acetal resin, a plasticizer and a blending agent containing an aliphatic ring and at least one hydroxyl group, wherein the blending agent is present in an amount of at least 0.005 phr. The laminate also exhibits a transparency of greater than 88.28, a mean break height of at least 4.50 meters and a yellowness index of less than 0.30.

By using the polymeric films as described herein a laminate having excellent optical properties and high impact resistance can be made. For example, the polymeric films described herein allow the formation of a laminated glass having high transparency, low haze, and a high impact resistance.

The above summary is not intended to represent every embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention and the appended claims.

### DETAILED DESCRIPTION

Polymeric films and laminates using these polymeric films are described herein. Improvements in optical properties and impact resistance have been found by, for example, using a blending compound in the resin used for the laminate, where the blending compound (also called a blending agent) includes an aliphatic ring and at least one hydroxyl group. By using the polymeric films as described herein, a laminate such as a laminated glass having excellent optical properties and high impact resistance can be made.

In some embodiments, the polymeric films comprise a polyvinyl acetal resin and one or more other resins, such as one or more additional thermoplastic resins. For example, and without limitation, the polymeric films can additionally include one or more resins selected from the group consisting of polyvinylidene fluoride, polytetrafluoroethylene, vinylidene fluoride-propylene hexafluoride copolymer, polytrifluoroethylene, acrylonitrile-butadiene-styrene copolymer, polyesters, polyethers, polyamides, polycarbonate, polyacrylate, polymethacrylate, polyurethane, polyvinyl chloride, polyethylene, polypropylene, polystyrene, polyvinyl acetal, and ethylene-vinyl acetate copolymer. In some embodiments, polymeric films comprise polyvinyl acetal resin.

In some embodiments, the polyvinyl acetal resin has a glass transition temperature (Tg) between about 50 and 100° C. (e.g., between about 60 and 80° C.).

In some embodiments, the polyvinyl acetal resin has a molecular weight of at least about 10,000 Mw (g/mol). For example, at least about 30,000, at least about 50,000 at least about 100,000 Mw (g/mol). In some embodiments, the polyvinyl acetal resins have molecular weight between about 10,000 and about 500,000 Mw (g/mol). In some embodiments, the polyvinyl acetal resins have molecular weight between about 100,000 and about 300,000 Mw (g/mol).

In some embodiments, the polymeric film includes a plasticizer. For example, the plasticizer is blended with the polyvinyl acetal to form the film. Some examples of plasticizers that can be used according to some embodiments include organic ester plasticizers such as monobasic organic esters and polybasic organic esters; and phosphate plasticizers such as organic phosphate plasticizers and organic phosphite plasticizers. In some embodiments, the plasticizer includes dibenzoates such as diethylene glycol dibenzoate or dipropylene glycol dibenzoate; citrates such as tributyl-o-acetyl citrate (ATBC) or tris-(2-ethylhexyl) o-acetyl citrate (ATEHC); polymeric plasticizers such as polyadipates; and glycol monoesters, glycol diesters and glycol triesters. In some embodiments, the plasticizer is selected from the group consisting of triethylene glycol bis(2-ethylhexanoate), triethylene glycol bis(2-ethylbutyrate), triethylene glycol bis(n-heptanoate), tetraethylene glycol bis(2-ethylhexanoate), tetraethylene glycol bis(2-ethylbutyrate), tetraethylene glycol bis(n-heptanoate), diethylene glycol bis(2-ethylhexanoate), diethylene glycol bis(2-ethylbutyrate), diethylene glycol bis(n-heptanoate), 2,2,4-trimethyl-1,3-pentanediol monoisobutyrate, dipentaerythritol hexaoctoate, dihexyl adipate, dioctyl adipate, hexyl cyclohexyl adipate, diisononyl adipate, heptylnonyl adipate, di(butoxyethyl) adipate, bis[2-(2-butoxyethoxy)ethyl] adipate, dibutyl sebacate, dioctyl sebacate, dibutyl phthalate, diethylene glycol dibenzoate, dipropylene glycol dibenzoate, glycerol, ethylene glycol, and combinations thereof. In some embodiments, the plasticizer is triethylene glycol bis(2-ethylhexanoate).

The amount of plasticizer can be used in any amount. In some embodiments, the amount of plasticizer used is in a range of 25 to 60 phr. In some embodiments, the amount of plasticizer used is at least 30 phr, at least 30 phr, at least 40 phr, at least 45 phr, at least 50 phr, or at least 55 phr. In some embodiments, the amount of plasticizer used is not more than 55 phr, not more than 50 phr, not more than 45 phr, not more than 40 phr, not more than 35 phr, or not more than 30 phr.

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. As used herein the terms “aliphatic” or “aliphatic group”, unless otherwise specified, contain 1-12 carbon atoms. In certain embodiments, aliphatic groups contain 1-20 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “cycloaliphatic” or “aliphatic ring,” used alone or as part of a larger moiety, refer to saturated or partially unsaturated cyclic aliphatic monocyclic, bicyclic, or polycyclic ring systems, wherein the aliphatic ring system is optionally substituted. Aliphatic rings include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, norbornyl, adamantyl, and cyclooctadienyl. In some embodiments, the cycloalkyl has 3-20 carbons. In some embodiments, the aliphatic ring is bicyclic. In some embodiments, the aliphatic ring is tricyclic. In some embodiments, the ring system is not or does not include an aromatic ring system.

In some embodiments, the aliphatic ring includes unsaturation such as where carbon atoms in the ring system that are bonded to each other are alkenyl groups (e.g., are doubly bonded to each other) or alkynyl groups (e.g., are triply bonded to each other). In these embodiments, the aliphatic ring or aliphatic ring system can refer to as an unsaturated derivative of an aliphatic ring.

In some embodiments, a blending agent containing an aliphatic ring and at least one hydroxyl group is used. For example, in some embodiments, the blending agent is a molecule having an aliphatic ring and a hydroxyl functional group. In some embodiments, the one or more hydroxyl group is directly bonded to a ring carbon of the aliphatic ring. In some embodiments, the one or more hydroxyl group is bonded to a functional group attached to a ring carbon, for example, an alkyl, alkenyl, or alkynyl group that is attached to the aliphatic ring such as a hydroxyl substituted(C₁-C₆)alkyl. In some embodiments, the hydroxyl substituted alkyl is —(CH2)OH. In some embodiments, the blending agent is a molecule having an aliphatic ring and two hydroxyl groups.

Some representative carbon skeleton structures for the aliphatic ring are shown by structures (I), (II), (III), (IV), (V), (VI), (VII) and (VIII):

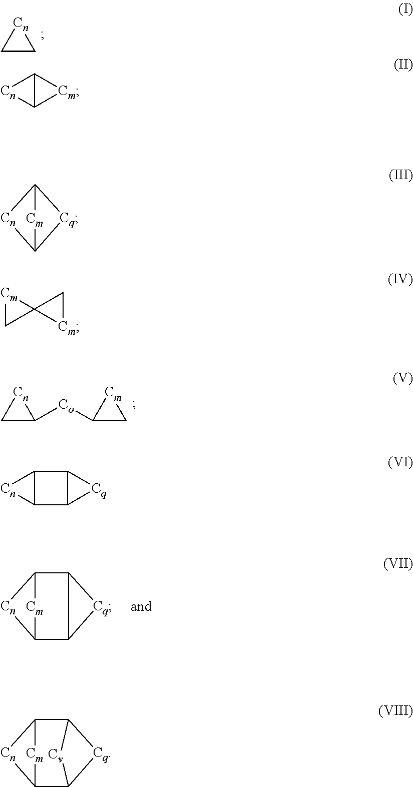

Wherein n, m, o, q and v are integers independently selected from 1-20. These structures show only the carbons that form the ring or connect rings and do not include hydrogens and functional groups that can be present such as aliphatic groups, hydroxyl groups, or hydroxyl substituted aliphatic groups. These structures also do not show more than three rings although it is understood that some embodiments include polycyclic structures with more than three rings. In addition, some embodiments can include combinations of these structures. In some embodiments, the carbon skeleton has the structure of (I) wherein n is 2, 3, 4, 5 or 6. In some embodiments, the carbon skeleton has the structure of (I) wherein n is 4. In some embodiments, the carbon skeleton has the structure of (II) wherein n is 2, 3, 4, 5 or 6 and m is 2, 3, 4, 5 or 6. In some embodiments, the carbon skeleton has the structure of (II) wherein n is 4 and m is 4. In some embodiments, the carbon skeleton has the structure of (V) wherein n is 2, 3, 4, 5 or 6; m is 2, 3, 4, 5 or 6; and o is 1, 2 or 3. In some embodiments, the carbon skeleton has the structure of (V) wherein n is 4; m is 4; and o is 1. In some embodiments, the carbon skeleton has the structure of (VII) wherein n is 2, 3, 4, 5 or 6; m is 1, 2, 3 or 4; and q is 2, 3, 4, 5 or 6. In some embodiments, the carbon skeleton has the structure of (VII) wherein n is 2; m is 1; and q is 3.

The term “cycloalkyl” or “monocycloalkyl” refers to a structure consisting of one cycloalkyl moiety. For example, having the carbon skeleton of structure (I). Some representative examples, without limitation, are clyclopropyl, cyclobutyl, cyclopentyl, cyclohexyl, cycloheptyl, cycloctyl, cyclononyl, cyclodecyl, as well the unsaturated derivatives thereof such as cyclopentenyl, cyclbutenyl, dicyclobutenyl, cyclopentenyl, cyclohexenyl, dicyclohexenyl, cycloheptenyl, and dicycloheptenyl.

The term “bicycloalkyl” refers to a structure consisting of two cycloalkyl moieties that have two or more atoms in common in the ring system. If the cycloalkyl moieties have exactly two atoms in common, they are said to be “fused”, for example having the carbon skeleton structure (II). Examples include but are not limited to bicyclo[2.1.0]pentyl, bicyclo[3.1.0]heptyl, and bicyclo[4.4.0]decyl. If the cycloalkyl moieties have more than two atoms in common, they are said to be “bridged,” for example having the carbon skeleton structure (III) where examples include, but are not limited to, bicyclo[2.2.1]heptyl (“norbornyl”), bicyclo[2.2.2]octyl, and the like.

The term “spiroalkyl” refers to a structure consisting of two cycloalkyl moieties that have exactly one atom in common. For example, the carbon skeleton for a spiroalkyl is shown by structure (IV). Examples include, but are not limited to, spiro[4.5]decyl, spiro[2.3]hexyl, and the like.

The term “tricycloalkyl” refers to a structure consisting of more than two cycloalkyl moieties that have four or more atoms in common. Some representative examples include the structures (VI), (VII) and (VIII). An example includes tricyclo[5.2.1.0]decyl.

In some embodiments, the aliphatic ring is functionalized for example with an aliphatic group or an aliphatic linker group. As used herein a “linker” group is a group that connects one functional group or moiety to one or more other functional groups or moiety. Structure (V) is an example of the compounds having a linker group, where the linker group is denoted as Cₒ to represent a carbon skeleton of the chain length “o” which can be substituted. For example, a linker aliphatic group such as —(CH2)ₙ— where n is an integer selected from 1 to 8 (e.g., 1-3) can form the linker group. In some embodiments, one or more alkyl groups is bonded to the carbon skeleton of the linker group. For example, the linker group can be —C(R^{a}R^{b})₂— where R^{a} and R^{b} are independently selected from an alkyl or hydrogen.

As used herein an “alicyclic alcohol” is any compound having an aliphatic ring as described herein and also including at least one hydroxyl functional group. For example, a compound having the carbon skeleton of structures (I), (II), (III), (IV), (V), (VI), (VII) or (VIII) and functionalized with a hydroxyl group or an alkyl hydroxyl group. In some embodiments, the alicyclic alcohol is selected from the group consisting of cyclohexanol; 1,2-cyclohexanediol; 1,3-cyclohexanediol, 1,4-cyclohexanediol; 1,5-cyclohexanediol; 1,2,3-cyclohexantriol, 1,3,5-cyclohexantriol, 1,2,4-cyclohexanetriol, 3-cyclohexen-1-ol, 2-cyclhexen-1-ol, cyclopropanol, cyclobutanol, cyclopentanol, 1,2-cyclobutanol; decahydro-1-naphthol; decahydro-2-naphthol; decalin-2,3-diol; decahydro-1,4-naphthalenediol; 1,5-decalindiol; decahydro-2,7-naphthalenediol; 2,2′-bis(4-hydroxycyclohexyl)propane; 1,4-cyclohexanedimethanol (CHDM); tricyclodecanedimethanol (TCDDM); 2-norbonanol; 5-norbornene-2-methanol; 5-norbornene-2,2-dimethanol; 5-norbornen-2-ol; 1-adamantanemethanol; 1-ethynyl-2,2, 6-trimethylcyclohexanol; 3-(hydroxymethyl)-1-adamantol; 1-adamantane ethanol; dicyclohexylmethanol; tricyclohexylmethanol; 1-(1-butynyl)cyclopentanol; 3-cyclohexyl-1-propanol; 4-iso-propylcyclohexanol; 1-adamantanol; 2-adamantanol; menthol; 2-tert-butylcyclohexano; 4-cyclohexyl-1-butanol; 4-tert-butylcyclohexanol; (1S,2R,5R)-2-(1-hydroxy-1-methylethyl)-5-methylcyclohexanol; dicyclopropyl carbinol; 1-ethylcyclopentanol; 1-methylcyclohexanol; 2-cyclopentylethanol; 2-methylcyclohexanol; 4-methylcyclohexanol ; cycloheptanol; cyclohexanemethanol; trans-4-methylcyclohexanol; 1-hydroxymethyl-1-methylcyclohexane; 2-cyclohexylethanol; 2-ethylcyclohexanol; 3,5-dimethylcyclohexanol; 3-cyclopentyl-1-propanol; 4-ethylcyclohexanol; 1-methylcyclopropanol; cyclopropanemethanol; 1-cyclopropylethanol; 1-methylcyclopropanemethanol; 2-cyclopropylethanol; 2-methylcyclopropanemethanol; cyclobutanemethanol; 1-methylcyclopentanol; 2-methylcyclopentanol; 3-methylcyclopentanol; cyclopentanemethanol; as well as any stereoisomers or mixtures of stereoisomers thereof. In some embodiments, the alicyclic alcohol is selected from the group consisting of 1,4-cyclohexanediol; 1,4-cyclohexanedimethanol (CHDM); tricyclodecanedimethanol (TCDDM); decahydro-2-naphthol; 2,2′-bis(4-hydroxycyclohexyl)propane; and cyclohexanol.

The blending agent can be used in any concentration to improve the properties such as the impact resistance or the optical properties. In some embodiments, the amount of blending agent in the polymeric film is at least 0.005 phr such as at least 0.01 phr, at least 0.02 phr, at least 0.03 phr, or at least 0.04 phr. In some embodiments, the amount is less than about 10 phr, such as less than about 5 phr or less than about 1 phr. Herein “phr” refers to weight parts of a component (e.g., a plasticizer, or an additive) present in 100 parts by weight of a resin.

In some embodiments, the polymeric film has enhanced optical properties such as high refractive index. For example, the polymeric film made using a polyvinyl acetal resin, a plasticizer and a blending agent, where the blending agent includes an aliphatic ring and at least one hydroxyl group, has a refractive index than a comparative polymeric film where the blending agent is not present or is a different compound such as an aromatic compound, does not include a cyclic aliphatic compound or does not include hydroxyl groups. In some embodiments, the refractive index of the polymeric film is at least 1.460, such as at least 1.470, at least 1.480, at least 1.490, at least 1.500.

In some embodiments, the polymeric film can be used to form a laminate where the polymeric film forms an interlayer material between two sheets of a transparent material to form the laminate. The transparent material can be any material including glass, polycarbonate, polyacrylate, polyethylene terephthalate (PET). In some embodiments, the transparent material is glass, such as a silicate glass, wherein in this embodiment the laminate is a laminated glass. Some examples of the glass include a flat glass, and a float glass. In some embodiments, the laminate includes several alternating layers of the transparent material and interlayer material.

In some embodiments, the laminate made using the polymeric film has enhanced optical properties such as high transparency, and low yellowness index. For example, the laminate made using a polyvinyl acetal resin, a plasticizer and a blending agent, where the blending agent includes an aliphatic ring and at least one hydroxyl group, has a higher transparency and lower yellowness index than a comparative laminate where the blending agent is not present or is a different compound such as an aromatic compound, does not include a cyclic aliphatic compound or does not include hydroxyl groups. In some embodiments, the transparency of the laminate is at least 88.28%, such as at least 88.3%, at least 88.4%, at least 88.5%, at least 88.6%, at least 88.7%, at least 88.8% or at least 88.9%.

In some embodiments, the difference in refractive index of the polymeric film used in the laminate and the refractive index of the glass used in making the laminate is less than or equal to 0.5, less than or equal to 0.2, or less than or equal to 0.1.

In some embodiments, the yellowness index of the laminate is less than 0.3, such as less than 0.29, less than 0.28, less than 0.27, less than 0.26, less than 0.25, less than 0.24, less than 0.23, less than 0.22, less than 0.21, or less than 0.20.

In some embodiments, the laminate made using the polymeric film has a high impact resistance. For example, the laminate made using a polyvinyl acetal resin, a plasticizer and a blending agent, where the blending agent includes an aliphatic ring and at least one hydroxyl group, has a higher impact resistance than a comparative laminate where the blending agent is not present or is a different compound such as an aromatic compound, does not include a cyclic aliphatic compound or does not include hydroxyl groups. In some embodiments, the impact resistance as measured by a Mean Break Height (MBH) measurement is greater than 4.5 meters such as greater than 4.7 meters, greater than 4.9 meters, greater than 5 meters, greater than 5.5 meters or even greater than 6 meters.

In some embodiments, the polymeric film used in the laminate can be more than 0.1 mm thick and less than about 2.0 mm thick, such as more than about 0.4 mm thick and less than about 1.2 mm thick, such as between 0.5 mm and 1.1 mm, between 0.6 mm and 1.0 mm, between 0.7 mm and 0.9 mm. In some embodiments, the polymeric film is 0.8 mm thick.

In some embodiments, the polymeric film used in the laminate can include one or more additives such as an acoustic control agent, dyes, pigments, stabilizers, antioxidants, flame retardants, infrared absorbers, infrared blockers, UV absorbers, UV stabilizers, lubricants, dispersants, surfactants, chelating agents, coupling agents, binders, or adhesive control agents.

In some embodiments, acoustic control agents are used to modulate the acoustic properties of the laminate. For example, and without limitation, polyester rubber, neoprene rubber, alumina, vinyl chloride/vinyl acetate copolymer resin, or one or more of these can be compounded with the polymeric film for sound attenuation at one or more frequency.

In some embodiments, one or more coloring agent such as pigments and dyes are added, for example, for aesthetic reasons or for protection from light. In these modifications it is understood that the properties described above might be modified. For example, the transparency would be modified by the addition of coloring agents. As used herein, the terms “pigment” and “dyes” refers to any material that changes color of reflected or transmitted light as the result of wavelength selective adoption. Dyes are soluble compounds, whereas pigments are generally solid particles. Pigments and dyes can include both organic and inorganic ones. In some embodiments, the pigment or dye used in the polymeric film is selected from one or more of Ultramarine violet (e.g., silicate of sodium and aluminum containing sulfur), Han Purple (BaCuSi₂O₆, cobalt pigments such as Cobalt Violet (e.g., cobaltous orthophosphate), manganese pigments such as Manganese violet (NH₄MnP₂O₇), Gold pigments such as Purple of Cassius: (e.g., gold nanoparticles suspended in tin dioxide, Ultramarine-PB29), Persian blue (e.g., ground Lapis lazuli), Cobalt Blue-PB28, Cerulean Blue-PB35, Egyptian Blue (e.g., calcium copper silicate, CaCuSi₄O₁₀), Manganese dioxide (e.g., MnO₂), Titanium Black (e.g., Ti₂O₃), Antimony White (e.g., Sb₂O₃), Barium sulfate-PW5 (e.g., BaSO₄), Lithopone (e.g., BaSO_{4*}ZnS), Cremnitz White-PW1 (e.g., (PbCO₃)2.Pb(OH)₂), Titanium White-PW6, (e.g., TiO₂), Zinc White-PW4 (e.g., ZnO), 1,2-dihydroxyanthraquinone, Phthalocyanine Blue BN, Phthalocyanine Green G, Pigment violet 23, Pigment Yellow 10, Pigment Yellow 12, Pigment Yellow 13, Pigment Yellow 16, Pigment Yellow 81, Pigment yellow 83, Pigment yellow 139, Pigment yellow 185, Quinacridone, Rose madder (e.g., alizarin and purpurin), Rylene dye, Tyrian purple, and (e.g., 6,6′-dibromoindigo).

In some embodiments, the polymeric film includes an adhesion control agent. Without limitation the adhesion control agent can be selected from monovalent or multivalent metal, e.g., divalent, salts of organic salts, such as C₁ to C₈ aliphatic or aromatic organic acids. For example, in some embodiments, the metal cation is sodium, potassium, magnesium, calcium or zinc and representative anions are acetate, butyrate, substituted butyrates such as 2-ethyl butyrate, and octanoate. In some embodiments, no adhesive control agent is used in the polymeric films.

In some embodiments, the polymeric film includes a UV stabilizer, such as one or more UV stabilizer. In some embodiments, the UV stabilizer is an UV light absorber, for example, carbon black, titanium oxide, benzophenones (e.g., hydroxybenzophenone and hydroxyphenylbenzotriazole), oxanilides, benzotriazoles, and hydroxyphenyltriazines. In some embodiments, the UV stabilizer is a quencher such as a nickel quencher. In some embodiments, the UV stabilizer is a free radical trapping agent such as compounds having a 2,2,6,6-tetramethylpiperidine ring structure also known as HALS (Hindered Amine Light Stabilizer).

In some embodiments, the polymeric films include antioxidants, such as one or more antioxidant. For example, and without limitation, antioxidants can be selected from phenols, amines, phosphites, thiols, hydroxylamine, lactone, vitamin E and combinations of these.

In some embodiments, the polymeric films include flame retardants, such as one or more flame retardant. In some embodiments, the flame retardant is a mineral or inorganic compound such as selected from the group consisting of aluminum hydroxide, boron compounds, antimony oxides, huntite, hydromagnesite, zinc oxides, montmorillonite clay (e.g., monodisperse clay), organomodified clay, layered double hydroxide, carbon nanotubes, polyhedral silsesquioxanes, and combinations of these. In some embodiments, the flame retardant is gas phase radical quencher such as chlorinated and brominated compounds. In some embodiments, the flame retardant is a thermal shielding compound such as phosphate-ester compounds.

It should be understood within the scope of the present disclosure, the above-mentioned technical features and technical features mentioned below (such as examples) can be combined freely and mutually to form new or preferred technical solutions, which are omitted for brevity.

### EXAMPLES

### 1. Preparation of Polymeric Film

A mixture was prepared by dry-blending 100 parts by weight of polyvinyl butyral resin with 38.5 parts by weight of a plasticizer (3GO, triethylene glycol bis(2-ethylhexanoate)) and a blending agent, where the amount of the blending agent is shown in Table 1. The mixture was kneaded at 35 rpm with a mixing machine (Brabender®, Germany, Mixer 50 EHT) at 120° C. for 15 minutes to form a well-mixed molten material. The material was then allowed to cool to ambient temperature to provide plastic blocks. The plastic blocks were pressed with a hot-press machine (GOTECH, Taiwan, GT-7014-A) at 150° C. for 3 minutes to provide a polymeric film having a thickness of 0.8 mm.

### 2. Preparation of a Laminated Glass

The polymeric film as described above having a thickness of 0.8 mm was interposed between a pair of transparent float glass sheets to provide a laminated glass. Each glass sheet had a thickness of 3 mm. Clear Float Glass (thickness 3 mm, manufactured by Taiwan Glass Ind. Corp.) was used. A hot-presser (GOTECH, Taiwan, GT-7014-A) was used to prepress the laminated glass at 150° C. for 3 minutes. Following the prepress procedure, the laminated glass was autoclaved at 13 bar and 135° C. for 120 minutes and subsequently cooled to ambient temperature to complete the lamination process.

Table 1 shows examples of laminated glass that were prepared.

### 3. Properties of the Laminated Glass

Table 2 shows the properties for laminates made according to some embodiments described herein.

As a result, the examples of the polymeric films as defined in the subject application, have higher refractive index than those of other polymeric films where the blending agent is not present or is a different compound such as an aromatic compound, does not include a cyclic aliphatic compound or does not include hydroxyl groups.

Furthermore, the examples of laminates comprising the polymeric film as defined in the subject application, have higher transparency and lower yellowness index than those of other laminates where the blending agent is not present or is a different compound such as an aromatic compound, does not include a cyclic aliphatic compound or does not include hydroxyl groups.

Furthermore, the examples of laminates made using a polyvinyl acetal resin, a plasticizer and a blending agent, where the blending agent includes an aliphatic ring and at least one hydroxyl group, has a higher impact resistance than that of laminates where the blending agent is not present or does not include a cyclic aliphatic compound or hydroxyl groups, but using different compound such as an aromatic compound.

As above, by using the polymeric films as described herein, laminates having excellent optical properties and high impact resistance can be made. For example, the polymeric films described herein allow the formation of a laminates having high transparency, low haze, and a high impact resistance.

TABLE 1

| | | Amount |
|---|---|---|
| | Blending Agent | (phr) |
| Exp. 1 | — | — |
| Exp. 2 | tricyclodecane dimethanol | 0.0055 |
| Exp. 3 | tricyclodecane dimethanol | 0.014 |
| Exp. 4 | tricyclodecane dimethanol | 0.14 |
| Exp. 5 | tricyclodecane dimethanol | 0.7 |
| Exp. 6 | tricyclodecane dimethanol | 1.26 |
| Exp. 7 | tricyclodecane dimethanol | 1.4 |
| Exp. 8 | 1,4-cyclohexanedimethanol | 0.014 |
| Exp. 9 | 1,4-cyclohexanedimethanol | 0.14 |
| Exp. 10 | cyclohexanol | 0.14 |
| Exp. 11 | 1,4-cyclohexanediol | 0.14 |
| Exp. 12 | decahydro-2-naphthol | 0.14 |
| Exp. 13 | 2,2′-bis(4-hydroxycyclohexyl)propane | 0.14 |
| Exp. 14 | n-hexene | 0.14 |
| Exp. 15 | cyclohexane | 0.14 |
| Exp. 16 | 2,7-dihydroxynaphthalene | 0.14 |
| Exp. 17 | bisphenol A | 0.14 |
| Exp. 18 | 1,6-hexanediol | 0.14 |
| Exp. 19 | 1,4-butanediol | 0.14 |
| Exp. 20 | 2-methyl-1,3-propanediol | 0.14 |

TABLE 2

| | Exp. | Exp. | Exp. | Exp. | Exp. | Exp. | Exp. | Exp. | Exp. | Exp. |
|---|---|---|---|---|---|---|---|---|---|---|
| | 1 | 2 | 3 | 4 | 5 | 6 | 7 | 8 | 9 | 10 |
| Refractive | 1.436 | 1.468 | 1.488 | 1.51 | 1.52 | 1.52 | 1.52 | 1.499 | 1.508 | 1.468 |
| Index | | | | | | | | | | |
| Refractive | — | 2.23 | 3.62 | 5.15 | 5.85 | 5.85 | 5.85 | 4.39 | 5.01 | 2.23 |
| Index | | | | | | | | | | |
| Increase | | | | | | | | | | |
| (%) | | | | | | | | | | |
| Transparency | 88.25 | 88.53 | 88.7 | 88.9 | 88.92 | 88.93 | 88.94 | 88.67 | 88.71 | 88.29 |
| (%) | | | | | | | | | | |
| Transparency | — | 14 | 22.72 | 32.32 | 33.5 | 34 | 34.5 | 21.21 | 23.23 | 2.01 |
| Increase | | | | | | | | | | |
| (%) | | | | | | | | | | |
| Yellowness | 0.31 | 0.23 | 0.2 | 0.13 | 0.1 | 0.08 | 0.08 | 0.26 | 0.24 | 0.28 |
| Index | | | | | | | | | | |
| Yellowness | — | −25.81 | −35.48 | −58.06 | −67.74 | −74.19 | −74.19 | −16.13 | −22.58 | −11.11 |
| Index | | | | | | | | | | |
| Increase | | | | | | | | | | |
| (%) | | | | | | | | | | |
| Mean Break | 4.5 | 4.6 | 4.75 | 6.25 | 6.45 | 6.45 | 6.5 | 4.6 | 5.83 | 4.92 |
| Height | | | | | | | | | | |
| (m) | | | | | | | | | | |
| Mean Break | — | 2.22 | 5.56 | 38.89 | 43.33 | 43.33 | 44.44 | 2.22 | 29.56 | 9.33 |
| Height | | | | | | | | | | |
| Increase | | | | | | | | | | |
| (%) | | | | | | | | | | |
| Humidity | ◯ | ◯ | ◯ | ◯ | ◯ | ◯ | X | ◯ | ◯ | ◯ |
| Test | | | | | | | | | | |
| | Exp. | Exp. | Exp. | Exp. | Exp. | Exp. | Exp. | Exp. | Exp. | Exp. |
| | 11 | 12 | 13 | 14 | 15 | 16 | 17 | 18 | 19 | 20 |
| Refractive | 1.473 | 1.51 | 1.467 | 1.437 | 1.438 | 1.435 | 1.434 | 1.448 | 1.44 | 1.442 |
| Index | | | | | | | | | | |
| Refractive | 2.58 | 5.15 | 2.16 | 0.07 | 0.14 | −0.07 | −0.14 | 0.84 | 0.28 | 0.42 |
| Index | | | | | | | | | | |
| Increase | | | | | | | | | | |
| (%) | | | | | | | | | | |
| Transparency | 88.63 | 88.79 | 88.31 | 88.2 | 88.26 | 88.13 | 88.05 | 88.31 | 88.3 | 88.59 |
| (%) | | | | | | | | | | |
| Transparency | 19 | 27 | 3 | −2.5 | 0.5 | −6 | −10 | 3.01 | 2.5 | 17.08 |
| Increase | | | | | | | | | | |
| (%) | | | | | | | | | | |
| Yellowness | 0.25 | 0.21 | 0.27 | 0.36 | 0.35 | 0.42 | 0.58 | 0.25 | 0.28 | 0.25 |
| Index | | | | | | | | | | |
| Yellowness | −19.26 | −32.26 | −12.9 | 16.13 | 12.9 | 35.48 | 87.1 | −19.26 | −10.37 | −18.52 |
| Index | | | | | | | | | | |
| Decrease | | | | | | | | | | |
| (%) | | | | | | | | | | |
| Mean Break | 5.56 | 4.91 | 5.13 | 4.5 | 4.5 | 4.5 | 4.5 | 4.82 | 4.78 | 4.8 |
| Height | | | | | | | | | | |
| (m) | | | | | | | | | | |
| Mean Break | 23.56 | 9.11 | 14 | 0 | 0 | 0 | 0 | 7.11 | 6.22 | 6.67 |
| Height | | | | | | | | | | |
| Increase | | | | | | | | | | |
| (%) | | | | | | | | | | |
| Humidity | ◯ | ◯ | ◯ | ◯ | ◯ | ◯ | ◯ | ◯ | ◯ | ◯ |
| Test | | | | | | | | | | |

### 4. Test Methods

Refractive Index

The refractive index of the polymeric film was measured at 589 nm and 25° C. in accordance with ASTM D542.

Transparency

Transparency of the laminates were measured by using NDH-2000 (Nippon Denshoku, Japan). The measurement was done using the procedure of ASTM D 1003.

In order to more clearly show the differences in transparency, the increasing amount of transparency was calculated using the following equation:

Transparency increase (%)=(Transparencyexp-Transparencyexpi)/2% *100.

wherein Transparencyexp is the transparency for a particular experiment (Exp. 2-20); Transparencyexpi is the transparency for Exp. 1 (i.e., no blending agent added). The significance of “2%” is that the difference in transparency between glass and Exp. 1 is 2%; that is: Transparency_{glass}-Transparencyₑₓₚₗ=2%.

Yellowness Index (YI)

The yellowness index of the laminated glass was measured using ZE-2000 (Nippon Denshoku, Japan). The ASTM D1925 procedure was followed. Where ASTM D1925 was withdrawn in 1995, ASTM E313 can be relied upon for the relevant procedures.

Mean Break Height (MBH)

Impact resistance was evaluated by a ball drop test method referred to herein as Mean Break Height (MBH) and described as follows. The sample, such as a laminated glass having dimensions of 300 mm*300 mm, is supported horizontally in a support frame at 20˜23° C. A 2.26 kg steel ball is dropped onto the laminated glass from a height near the expected MBH. If the ball penetrates the laminated glass, the test is repeated from a drop height 0.5 m lower than the previous test. If the ball is held by the laminated glass (that is, the ball does not penetrate the laminated glass), the test is repeated from a drop height 0.5 m higher than the previous test. Ten laminated glasses are tested to set the MBH.

The MBH is defined as the ball drop height at which 50% of the samples hold the ball and 50% allow penetration through the sample. The result that the ball does not penetrate the sample is recorded as “pass.” The results are tabulated and the percent pass at each ball drop height is calculated. These results are graphed as percent pass versus ball drop height and a line representing the best fit of the data is drawn on the graph. The MBH can be read from the graph at the point where the percent pass is 50%. For example, for illustration with a small sample size, the data as shown in Table 3 was collected. A plot of the Pass % vs the Height is made and the value for Height at which the Pass % is found e.g., interpolated, is the MBH. For the data shown in Table 3, this is about 4.78 m. In an actual test, ten samples are used to obtain the MBH and the test is repeated three times. Therefore, the MBH for the data presented in Table 2 is determined with 30 samples.

TABLE 3
Some representative data collect for the MBH.

| | | | Pass/Sample*100 |
|---|---|---|---|
| Height (m) | Sample | Pass | or Pass % |
| 5.5 | 1 | 0 | 0 |
| 5 | 3 | 1 | 33.33 |
| 4.5 | 4 | 3 | 75 |
| 4 | 1 | 1 | 100 |

Humidity Test

A laminated glass (300 mm*300 mm) was conditioned at a temperature of 50° C. and a relative humidity of 95% for 14 days in a chamber. The laminated glass was then maintained for two hours in the ambient atmosphere. Three laminated glasses were evaluated. The test was recorded in Table 2 as “O” if no significant change is seen in three laminated glasses or “X” if a significant change is seen in at least one of the laminated glasses. Here, no significant change means that there are no bubbles, no delamination and no whitening observed in the area more than 10 mm from uncut edges and more than 15 mm from cut edges of the laminated glass.

As used herein the term “comprising” or “comprises” is used in reference to compositions, methods, and respective component(s) thereof, that are essential to the claimed invention, yet open to the inclusion of unspecified elements, whether essential or not.

As used herein the term “consisting essentially of” refers to those elements required for a given embodiment. The term permits the presence of elements that do not materially affect the basic and novel or functional characteristic(s) of that embodiment of the claimed invention.

The term “consisting of” refers to compositions, methods, and respective components thereof as described herein, which are exclusive of any element not recited in that description of the embodiment.

As used in this specification and the appended claims, the singular forms “a,” “an,” and “the” include plural references unless the context clearly dictates otherwise. Thus for example, references to “the method” includes one or more methods, and/or steps of the type described herein and/or which will become apparent to those persons skilled in the art upon reading this disclosure and so forth. Similarly, the word “or” is intended to include “and” unless the context clearly indicates otherwise.

Other than in the operating examples, or where otherwise indicated, all numbers expressing quantities of ingredients or reaction conditions used herein should be understood as modified in all instances by the term “about.” The term “about” when may mean ±5% (e.g., ±4%, ±3%, ±2%, ±1%) of the value being referred to.

Where a range of values is provided, each numerical value between and including the upper and lower limits of the range is contemplated as disclosed herein. It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

Unless otherwise defined herein, scientific and technical terms used in connection with the present application shall have the meanings that are commonly understood by those of ordinary skill in the art. Further, unless otherwise required by context, singular terms shall include pluralities and plural terms shall include the singular.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

Any patents, patent applications, and publications including ASTM, JIS methods identified that are disclosed herein are expressly incorporated herein by reference for the purpose of describing and disclosing, for example, the methodologies described in such publications that can be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A polymeric film comprising:
a polyvinyl acetal resin;
a plasticizer; and, a blending agent containing an aliphatic ring and at least one hydroxyl group, wherein the blending agent is present in an amount in the range of 0.0055 to 0.14 phr.

2. The polymeric film of claim 1, wherein the blending agent is an alicyclic alcohol.

3. The polymeric film of claim 1, wherein the aliphatic ring has a polycyclic structure.

4. The polymeric film of claim 1, wherein the aliphatic ring comprises an alicyclic hydrocarbon group.

5. The polymeric film of claim 4, wherein the alicyclic hydrocarbon group has 3 to 12 carbons.

6. The polymeric film of claim 4, wherein the alicyclic hydrocarbon group is selected from the group consisting of a cycloalkyl, a fused bicycloalkyl, a spiroalkyl, a bridged bicycloalkyl, and a first cycloalkyl linked to a second cycloalkyl by a C₁-C₃ alkyl chain.

7. The polymeric film of claim 6, wherein the aliphatic ring is substituted with at least one hydroxyl group or at least one hydroxyl substituted(C₁-C₆) alkyl.

8. The polymeric film of claim 1, wherein the blending agent is at least one selected from the group consisting of tricyclodecane dimethanol (TCDDM), 1,4-cyclohexanedimethanol (CHDM), 2,2′-bis(4-hydroxycyclohexyl)propane (HBPA), decahydro-2-naphthol, cyclohexanol, and 1,4-cyclohexanediol.

9. The polymeric film of claim 8, wherein the blending agent is tricyclodecane dimethanol (TCDDM).

10. The polymeric film of claim 1, wherein the blending agent contains at least two hydroxyl groups.

11. The polymeric film of claim 1, wherein the polyvinyl acetal resin is polyvinyl butyral resin.

12. The polymeric film of claim 1, wherein the plasticizer comprises triethylene glycol bis(2-ethylhexanoate).

13. (canceled)

14. The polymeric film of claim 1, wherein the polymeric film exhibits a refractive index of at least 1.460.

15. A laminate comprising outer transparent laminae and an interlayer comprising the polymeric film of claim 1.

16. The laminate of claim 15, wherein the outer transparent laminae are glass.

17. The laminate of claim 16, wherein the laminate exhibits a transparency of greater than 88.28.

18. The laminate of claim 16 wherein the laminate exhibits a yellowness index of less than 0.30.

19. The laminate of claim 16, wherein the laminate exhibits a mean break height of greater than 4.50 meters.

20. A laminate comprising:
two outer layers of glass and an interlayer of a polymeric film comprising a polyvinyl acetal resin, a plasticizer and a blending agent containing an aliphatic ring and at least one hydroxyl group, wherein the blending agent is present in an amount in the range of 0.005 to 0.14 phr;
wherein the laminate exhibits a transparency of greater than 88.28;
wherein the laminate exhibits a mean break height of at least 4.50 meters;
wherein the laminate exhibits a yellowness index of less than 0.30.
